(19) United States
(12) Patent Application Publication
(10) Pub. No.: US 2004/0234379 A1
(43) Pub. Date: Nov. 25, 2004

(54) Direct current magnetohydrodynamic pump configurations

(75) Inventors: Andrew Carl Miner, Austin, TX (US); Uttam Ghoshal, Austin, TX (US); Key Kolle, Luling, TX (US)

Correspondence Address: William L. Botjer, PO Box 478, Center Moriches, NY, 11934, US

(73) Assignee: NANOCOOLERS, INC., Austin, TX

(21) Appl. No.: 10/443,190

(22) Filed: May 22, 2003

(51) Int. Cl. H02K 44/08

(52) U.S. Cl. 417/50

(57) ABSTRACT

The present invention provides configurations of direct current magnetohydrodynamic (DC MHD) pumps for enhanced performance in pumping of conducting fluids. The pumping is achieved by a force developed by the interaction of magnetic flux and electric current. The force acting on the conducting fluid can be increased by increasing the magnetic flux density or the path length of charge carriers. The path length of charge carriers is increased by using a centrifugal configuration of the pump. The magnetic flux density is increased by using unique magnet configurations. A two-magnet configuration, a four-magnet configuration or a Halbach array configuration is used to enhance the magnetic flux density in the fluid cavity.

### BACKGROUND

The present invention relates to Direct Current Magnetohydrodynamic (DC MHD) Pumps. More specifically, the invention relates to DC MHD pumps with improved pumping capability.

MHD pumps are used for pumping of conductive fluids such as liquid metals. These pumps find use in devices such as electricity generators, propulsion systems and micro electromechanical systems. Exemplary applications of MHD pumps are for mercury pumping in electrolyte baths in the production of chlorine and caustic soda, controllable feeding of smelt, mixing and pumping of melted aluminum and magnetohydrodynamic stirrers.

MHD pumps are more reliable and safe compared to other pumps, as MHD pumps do not have any moving parts (with the exception of the conductive fluid itself).

The conductive fluids are pumped by taking advantage of the phenomenon wherein a charge carrier moving in a magnetic field experiences a force perpendicular to both its direction of motion and the magnetic field. The force (F) of many moving charge carriers, or a current (I), moving a distance (L) in a magnetic flux density (B) is expressed as F=BIL.

The simplest implementation of such a pump is accomplished by applying a DC bias across a channel of liquid metal in a magnetic field. FIG. 1 shows the principle of a DC MHD pump for pumping of conductive fluids. A DC MHD pump 102 comprises a pair of electrode plates 104 placed vertically facing each other. A DC voltage applied across electrode plates 104, produces an electric current across electrode plates 104. Permanent magnets 106 are arranged facing each other above and below the plane containing electrode plates 104. A tube 108 carries the conductive fluid. The direction of the magnetic field generated by permanent magnets 106 is perpendicular to the direction of flow of electric current. An electromagnetic force acts on the fluid causing it to flow in a direction perpendicular to the plane of electric current and magnetic fields (as shown by the block arrow in FIG. 1).

To improve the pumping capability of a DC MHD pump, the net electromagnetic force on the conductive fluid in the pump should be increased. There are several methods by which the net force on the conductive fluid can be increased. For example, the net force can be increased by increasing the current flowing in the liquid, the magnetic flux density or the path traveled by the charge carriers. The magnetic flux density can, in turn, be increased by bringing the permanent magnet poles closer to each other or by using larger magnets. However, these methods of improving the pumping capability of the DC MHD pump have limitations. An increase in the current can lead to excessive power dissipation. Bringing the permanent magnet poles closer together constricts the fluid flow path and increases internal drag, while the use of large magnets might be limited by the overall size of the device.

There have been attempts at designing DC MHD pumps with improved pumping capability. U.S. Pat. No. 6,241,480, titled “Micro-Magnetohydrodynamic Pump And Method For Operation Of The Same”, discloses one such micro linear magnetohydrodynamic pump. The pump comprises a valving piston and a pumping piston. The valving piston and the pumping piston are magnetohydrodynamically driven to control a working fluid. The pump provides a way to move the fluid at a low and controllable rate.

Another U.S. Pat. No. 5,009,399, titled “Device For Transfer Of Molten Metal”, discloses a device comprising a centrifugal conduction MHD pump arranged within a molten metal bath for transfer of molten metal. The patent discusses architecture for centrifugal MHD pump.

Another U.S. Pat. No. 5,993,164, titled “Method And Apparatus For An Electromagnetic Propulsion System”, discloses a method and apparatus to amplify the magnetic field in an electromagnetic circuit.

All these patents provide MHD pumps and ways to enhance their performance. However, the abovementioned patents suffer from one or more of the following limitations. The pumps described in the patents fail to address the need of providing optimal performance of MHD pumps for a given pump size. An increase in the pumping capability can only be achieved at the cost of increased internal drag, excessive power dissipation or a large pump size.

Hence, there is a need for improving the performance of MHD pumps to achieve higher pumping capability. The increase in the pumping capability of the MHD pump should not be accompanied with an increase in undesirable factors such as internal drag or power dissipation.

### SUMMARY

In accordance with one aspect, the present invention provides a centrifugal DC MHD pump to increase the pumping capability. The pump comprises a housing that encloses a working chamber filled with conductive fluid. A pair of electrodes in the working chamber provides current flow. The electrode pair comprises an electrode in the shape of a hollow cylinder enclosing a fluid cavity and another electrode located at the center of the fluid cavity. A magnetic circuit generates magnetic field in the fluid cavity in a direction perpendicular to the direction of current flow. This results in a force on the conductive fluid in a direction perpendicular to the plane of magnetic field and current flow. The force accelerates the fluid in a circular pattern. The fluid particles travel multiple rounds around the central electrode before exiting from the fluid cavity. This increase in path length allows the fluid to experience the magnetic force for a longer period than a typical linear pump. The fluid exits from the fluid cavity at a high velocity thereby producing useful pumping.

In accordance with another aspect, the present invention provides unique magnet configurations for increasing the magnetic flux density in a fluid cavity for enhanced performance in direct current magnetohydrodynamic (DC MHD) pump. A two-magnet configuration, a four-magnet configuration or a Halbach array configuration are provided. The configurations have directions of magnetization of the magnets aligned in a manner to increase the magnetic flux density in the pump.

In accordance with a further aspect, the present invention provides a centrifugal pump with a three-magnet configuration for enhancing the pumping capability of a DC MHD pump. The magnets at the top and bottom of the fluid cavity have the directions of magnetization pointing in the same direction. The magnet at the perimeter of the fluid cavity has a direction of magnetization opposite to the other two magnets. The magnetic configuration increases the magnetic flux density in the fluid cavity. The centrifugal configuration and the three-magnet configuration enhance the pumping capability of the DC MHD pump.

### BRIEF DESCRIPTION OF THE DRAWINGS

Various embodiments of the present invention will hereinafter be described in conjunction with the appended drawings provided to illustrate and not to limit the present invention, wherein like designations denote like elements, and in which:

FIG. 1 shows the principle of a direct current magnetohydrodynamic (DC MHD) pump for pumping of conductive fluids;

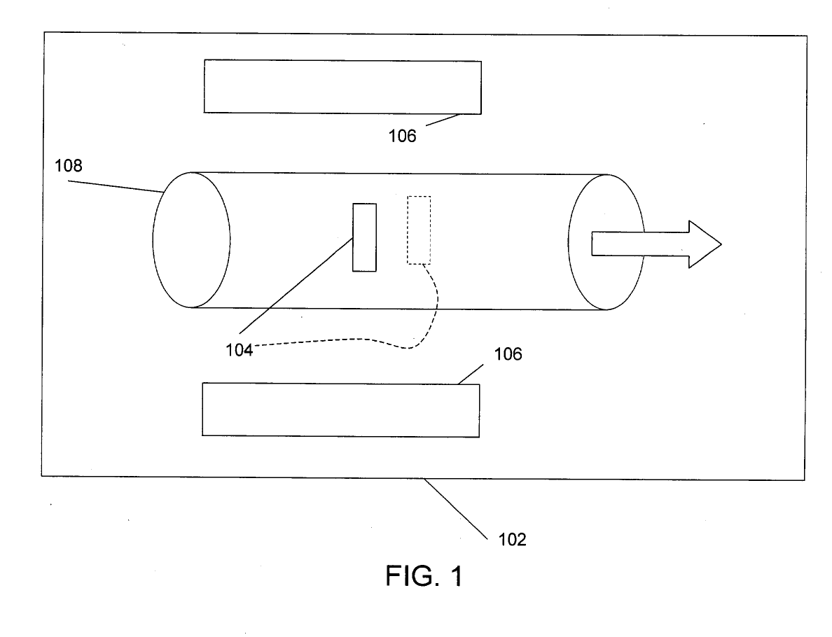

FIG. 2 is a top view of a centrifugal DC MHD pump;

FIG. 3 is a sectional view of a centrifugal MHD pump;

FIG. 4 shows magnetic field lines for a single magnet;

FIG. 5 shows a magnetic configuration using two magnets along with magnetic field lines for the magnets;

FIG. 6 shows a magnetic configuration using four magnets along with magnetic field lines for the magnets;

FIG. 7 shows the implementation of a magnetic configuration using four magnets for a linear MHD pump;

FIG. 8 is a schematic diagram of a Halbach array for use in a linear MHD pump;

FIG. 9 is a magnet configuration using a linear Halbach array for use in a linear MHD pump;

FIG. 10 is a top view of a centrifugal DC MHD pump using a three magnet configuration for improved pumping capability; and

FIG. 11 is a cross-sectional view of a centrifugal DC MHD pump using a three magnet configuration for improved pumping capability.

### DESCRIPTION OF PREFERRED EMBODIMENTS

The present invention provides configurations of DC MHD pumps for enhancing the pumping capability of such pumps. The pumping capability is enhanced by using a centrifugal configuration of MHD pumps for pumping a conductive fluid. The net force on the conductive fluid accelerates the fluid in a circular pattern. The fluid particles travel multiple rounds before exiting from the pump. This increase in path length allows the fluid to experience the force for a longer period than a typical linear pump. The fluid exits from the pump at a much higher velocity thereby increasing pumping capability.

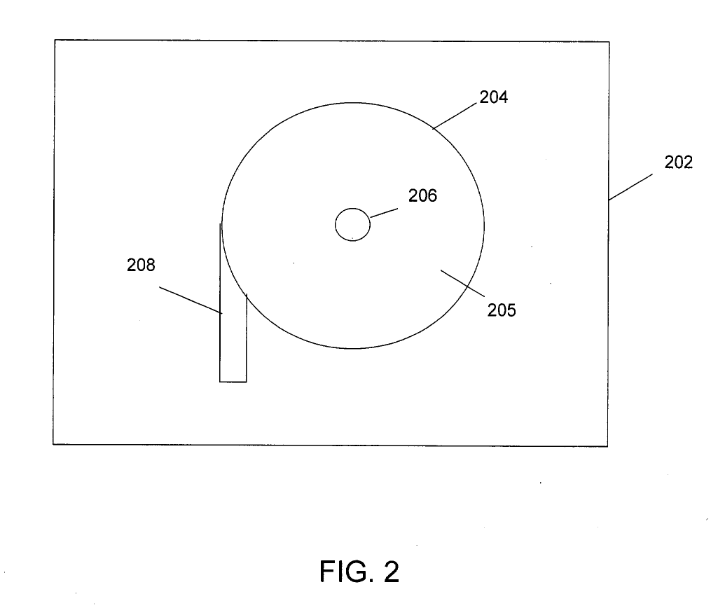

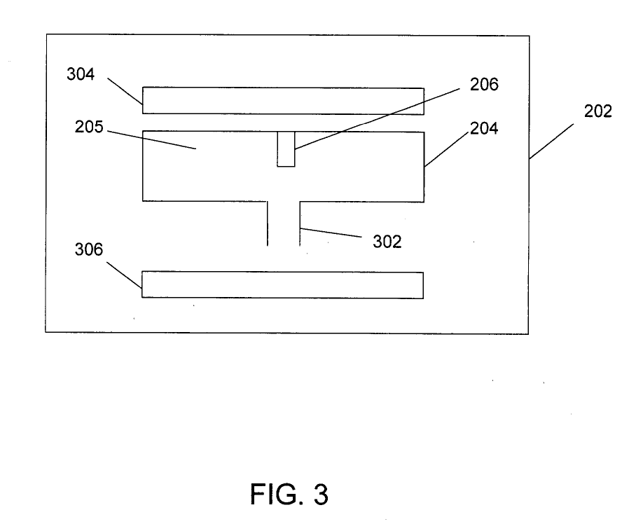

FIG. 2 shows a top view of centrifugal configuration of a DC MHD pump with enhanced pumping capability. The pump comprises a housing 202 enclosing a working chamber within. The housing is typically made of a non-conducting material such as plastic. The working chamber is filled with a conducting fluid. An electrode 204 having the shape of a hollow cylinder encloses a fluid cavity 205 with a circular cross-section. Electrode 204 forms the perimeter of fluid cavity 205 and is called the perimeter electrode. Another electrode 206 is located at the center of fluid cavity 205 and is termed as the central electrode. Magnets are provided at the top and bottom of fluid cavity 205 to generate a magnetic field. The magnets are not visible in this view (see FIG. 3). An outlet port 208 is provided at the perimeter of fluid cavity 205. Outlet port 208 allows the conductive fluid to exit tangentially from fluid cavity 205.

FIG. 3 shows a cross-sectional view of the centrifugal MHD pump shown in FIG. 2. The figure shows central electrode 206 located at the top of fluid cavity 205. An inlet port 302 is provided on the axis of fluid cavity 205 to allow the fluid to enter cavity 205. In the preferred embodiment, inlet port 302 is located at the bottom of fluid cavity 205. Central electrode 206 may or may not extend to the bottom of fluid cavity 205. To provide a magnetic field in the pump, magnets 304 and 306 are located at the top and bottom of fluid cavity 205.

In the centrifugal DC MHD pump shown in FIG. 2 and 3, the pumping is provided by an interaction of magnetic field and current flow. The magnetic field can be produced by permanent magnets located on the top and/or bottom of the device, or by an electromagnet solenoid circuit on the perimeter of the device. The orientation of the magnetic field is in a vertical direction. A bias applied between perimeter electrode 204 and central electrode 206 leads to the flow of current in the conductive fluid. The flow of current is radially outwards from central electrode 206 to perimeter electrode 204.

The current flow in a direction perpendicular to the direction of magnetic field causes the fluid to experience a force. The force is in a direction perpendicular to both the magnetic field and the current flow. The force accelerates the fluid in a circular pattern. The fluid also experiences a centrifugal force accelerating and moving the fluid away from the axis. Due to the acceleration, the velocity of the fluid increases until the fluid finally exits from outlet port 208 at a high velocity. This high-velocity fluid can be used to produce a useful pumping effect.

The improved pumping capability of a centrifugal pump is a result of increase in the path traveled by fluid particles in a centrifugal pump as compared to a linear pump. The fluid particles travel multiple rounds before exiting from fluid cavity 205. This increase in path length allows the fluid to experience the force for a longer period than a typical linear pump. This force accelerates the fluid and causes the fluid to exit at a much higher velocity (as compared to fluid in a corresponding linear pump). This high velocity fluid exiting from outlet port produces useful pumping.

As the fluid moves out of the outlet port 208, a low pressure is created at the axis of fluid cavity 205. The low pressure at the axis of fluid cavity 205 forces the fluid present in the working chamber to enter fluid cavity 205 through inlet port 302.

In the preferred embodiment, the central electrode is shown to be a single conductor located at the top of fluid cavity 205 and the perimeter electrode is shown as a continuous conductor. However, in alternate embodiments the central electrode may be located on the top or bottom of fluid cavity 205 and multiple electrodes can be located centrally instead of a single electrode. The perimeter electrode can also be one or more discrete conductors located on or near the perimeter of the device. In the preferred embodiment, inlet port 302 is located at the bottom of fluid cavity 205. However, in alternate embodiments the inlet port may be located at the top or both at the top and bottom of fluid cavity 205.

In the preferred embodiment shown in FIG. 2 and 3 the pump has been depicted in the form of a cylinder with a circular cross-section placed in a vertical configuration. However this does not limit the present invention to circular cylinders only. It would be obvious to a person skilled in the art that the present invention can be extended to shapes such as a volute, cylinders with square and elliptical cross-sections and to various other topologies such as a sphere. Also, the pump may be placed in a horizontal configuration instead of a vertical configuration.

Another way to increase the force on the conducting fluid and improve the pumping capability of an MHD pump is by increasing the magnetic flux density. The use of unique arrangements of permanent magnets in DC MHD pumps can increase the magnetic flux density within the pump.

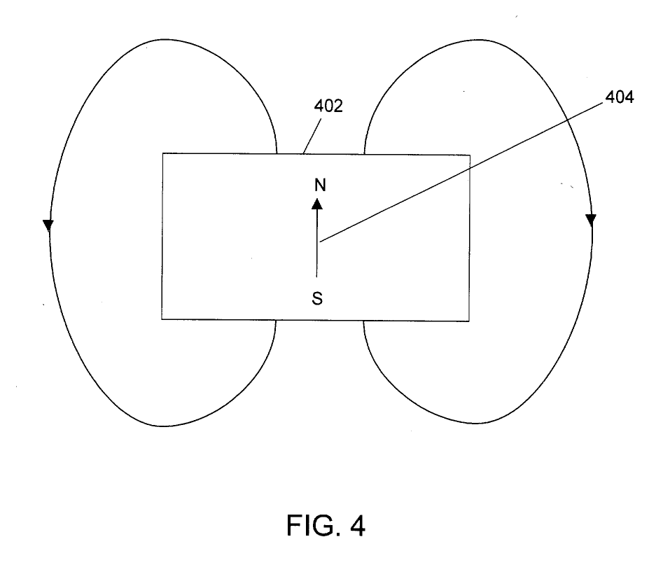

FIG. 4 shows magnetic field lines for a single magnet 402. The magnetic field lines are directed from north pole to south pole on the exterior of magnet 402. In the interior of magnet 402, the magnetic field lines are directed from south pole to north pole forming a closed loop. The magnetic field lines inside magnet 402 are represented by a direction of magnetization 404 of a magnet. The direction of magnetization of a magnet is directed from south pole to north pole of the magnet. As shown in FIG. 4, the direction of magnetization 404 of magnet 402 points in the upward direction. Such a magnet configuration is the simplest way to generate magnetic flux density in a DC MHD pump. Magnet 402 can be placed at the top or the bottom of the fluid cavity in a DC MHD pump. Thus magnet 402 can produce useful magnetic flux for the DC MHD pump.

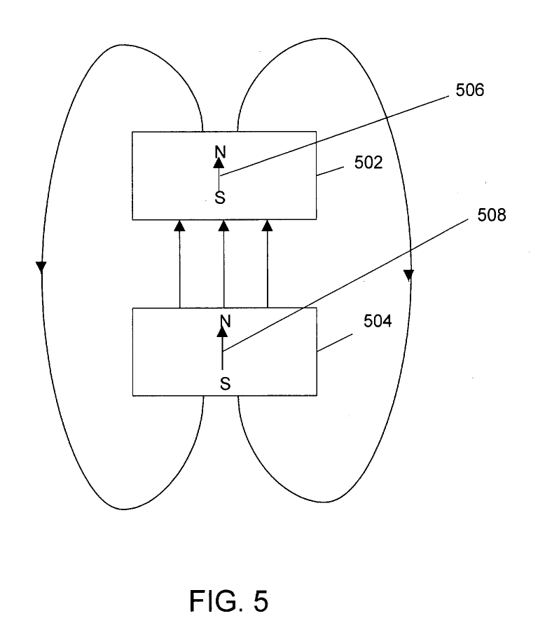

FIG. 5 shows a magnetic configuration using two magnets for providing the magnetic flux in an MHD pump. Magnets 502 and 504, with directions of magnetization 506 and 508 respectively, are arranged such that the south pole of magnet 502 faces the north pole of magnet 504. Directions of magnetization 506 and 508 of magnets 502 and 504 point in the same direction (upwards). Such a configuration of magnets increases the magnetic flux density in the region between the magnets as compared to the configuration shown in FIG. 4. Thus by using a two-magnet configuration in a DC MHD pump, a stronger magnetic flux density can be obtained in the pump. A stronger magnetic flux density in the pump would cause the fluid to experience a higher force, thereby producing useful pumping.

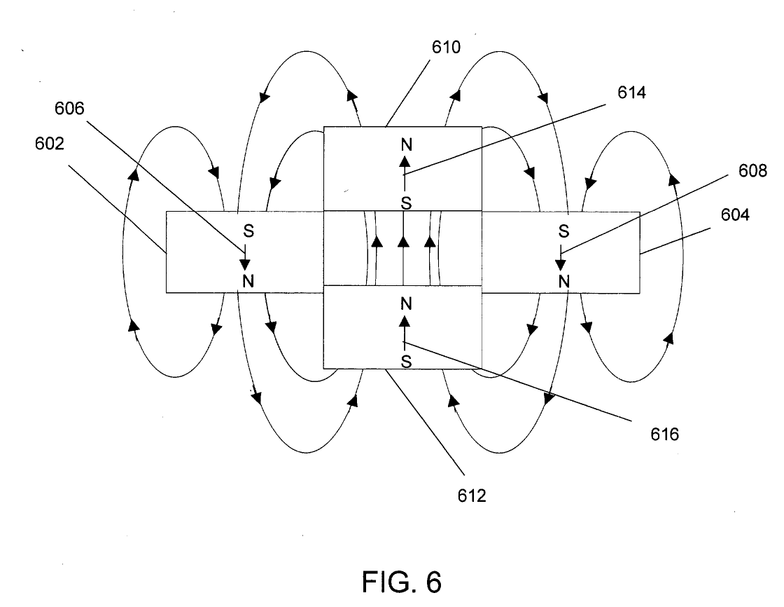

FIG. 6 shows a magnetic configuration using four magnets for providing magnetic flux in an MHD pump. As shown in the figure, magnets on the side 602 and 604 have their directions of magnetization 606 and 608 respectively, facing downward. Magnets 610 and 612 are placed with the poles in opposite directions relative to the poles of side magnets 602 and 604. Directions of magnetization 614 and 616 of magnets 610 and 612 respectively are in the upward direction. The magnetic flux density in the region enclosed by the four magnets is higher as compared to the flux density in the previous configurations. The use of such a configuration in a DC MHD pump would lead to improved pumping capability.

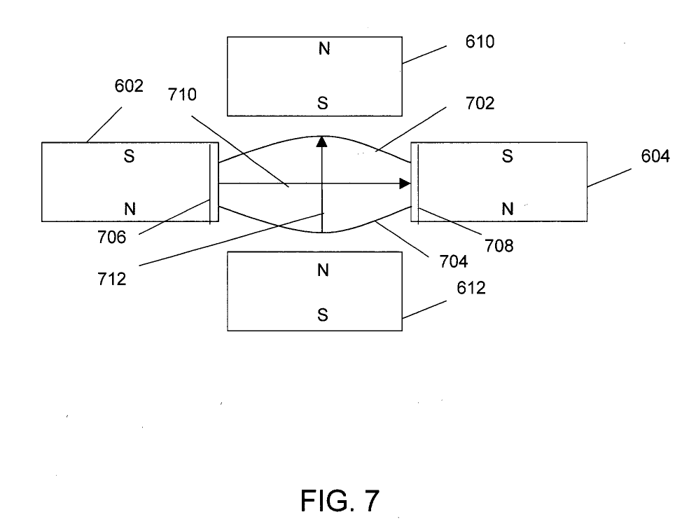

FIG. 7 shows implementation of magnetic configuration using four permanent magnets for linear MHD pumps. Lines 702 and 704 represent the perimeter of a cavity carrying the fluid in the linear MHD pump. It will be apparent that the cross section of the cavity may have any shape such as circular, elliptical, rectangular and so forth. As discussed in FIG. 6, the region enclosed by the four magnets has a high magnetic flux density. Magnets 602 and 604 can be electroplated with a conducting metal such as nickel to act as electrodes. The electrodes can also be accomplished by using inserts 706 and 708 composed of metal proximate to magnets 602 and 604. The current can be passed on providing a positive bias to magnet 602 as compared to magnet 604. The current flows along current path 710. Magnetic field direction 712 in the enclosed region is perpendicular to the current path 710. The fluid in the cavity experiences a force in the vertical direction along the axis due to the interaction of magnetic field and electric current. This force accelerates the fluid until the fluid exits at an elevated pressure producing pumping.

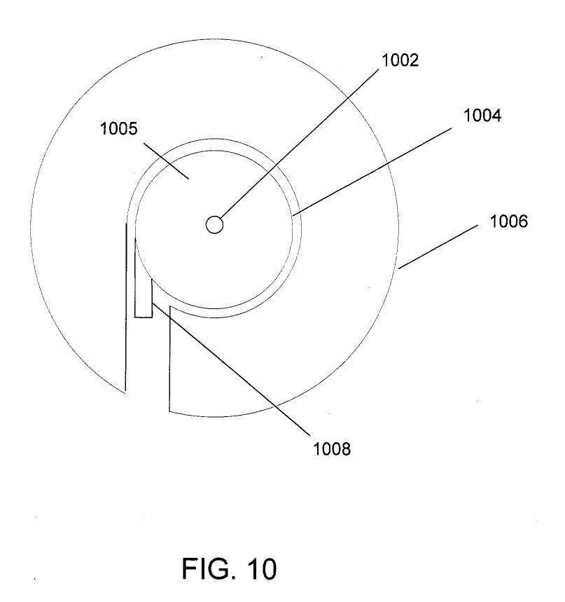

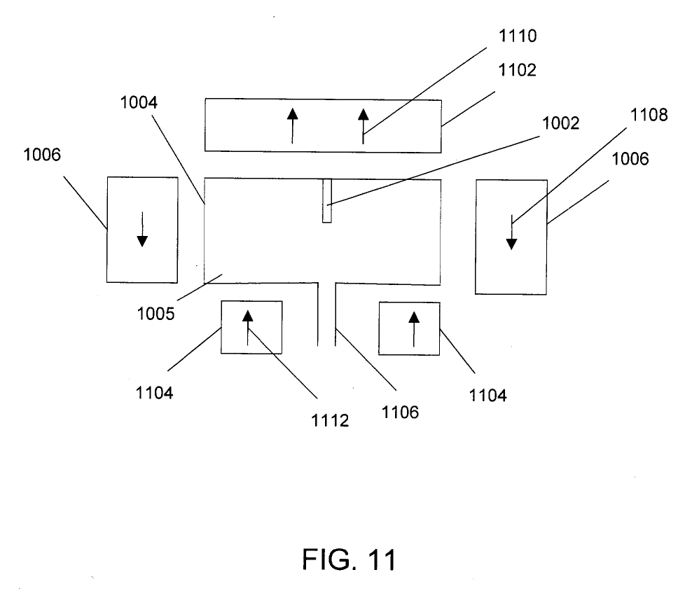

Similar architecture can be extended to a centrifugal MHD pump as is discussed in detail in FIG. 10 and 11.

Cylindrical “Halbach Array” configurations can also be used to enhance the magnetic field in linear MHD pumps. A Halbach array configuration comprises a plurality of magnets. The directions of magnetization of the magnets are oriented in a manner to produce high magnetic flux density inside the array and almost negligible magnet flux density outside the array. The configuration owes this characteristic to the particular arrangement of the magnetization vectors of the magnets. The magnetic flux densities, due to each of the magnets, inside the array add up to enhance the net magnetic flux density. However, the magnetic flux densities due to each of the magnets outside the array cancel each other resulting in negligible flux density. A more detailed explanation of the Halbach array configurations can be found in the reference: Michael Coey and Denis Weaire, “Magnets, Markets and Magic Cylinders”, The Industrial Physicist magazine, Volume 4, Number 3, Sep. 1998.

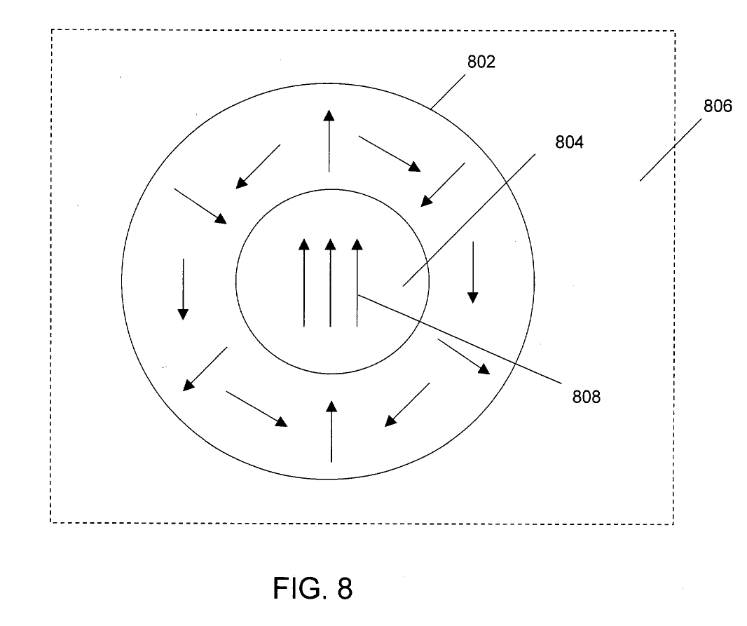

FIG. 8 shows a schematic diagram of a Halbach array. A Halbach array 802 generates a strong magnetic field in the region 804 enclosed by the Halbach array while negligible magnetic field in the region 806. Halbach array 802 is shown with 12 regions with different orientation of the magnetization. The domains at the 12, 3, 6 and 9 o'clock positions produce an intense, generally uniform magnetic field in the center of the structure and nonuniform fields outside the ring. The addition of properly oriented domains, such as those shown in FIG. 8 at positions 1,2,4,5,7,8,10 and 11 o'clock produce fields that effectively cancel unwanted fields external to the structure, and serve to increase the intensity and uniformity of the internal field. Line 808 represents the direction of the magnetic field in region 804. In case a conductive fluid channel is placed in the region 804 and current is passed in a direction perpendicular to the magnetic field, a force would be generated in the fluid along the axis. The high magnetic flux density increases the force acting on the fluid thereby enhancing the pumping capability of the MHD pump.

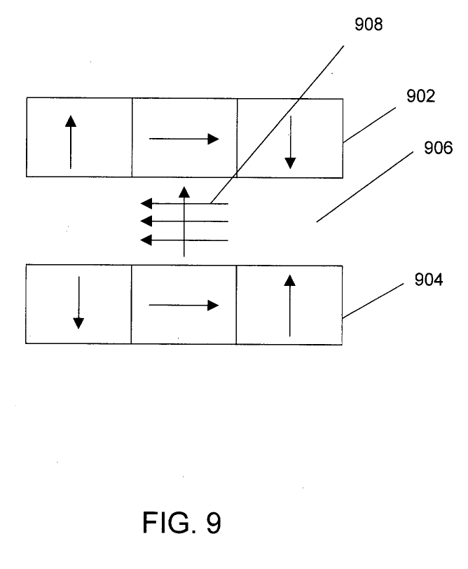

FIG. 9 shows a magnet configuration using a linear Halbach array composed of magnetic structures 902 and 904. Magnetic structures 902 and 904 are located at the top and bottom of a fluid channel respectively. Magnetic structures 902 and 904 comprise of a plurality of magnets. The direction of magnetization of the magnets is arranged to increase the magnetic flux density in region 906 between magnetic structures 902 and 904. Thus negligible magnetic flux density is generated outside of linear Halbach array. The particular arrangement of the directions of magnetization of the magnets leads to a magnetic flux density in a lateral direction as shown by line 908.

In a preferred embodiment of the present invention, magnetic structures 902 and 904 are electroplated with nickel to act as electrodes. An electric current is passed from magnetic structure 904 to magnetic structure 902 by applying a DC bias between the magnetic structures. The direction of the electric current is in a direction perpendicular to the magnetic field. A force acts on the fluid along the axis of the pump due to the interaction of the electric current and the magnetic flux density. The fluid can be used to provide useful pumping.

FIG. 10 shows a top view of a centrifugal DC MHD pump using a three magnet configuration for improved pumping capability. This configuration is similar to the four magnets configuration of FIG. 2 and 3. A central electrode 1002 and a perimeter electrode 1004 provide current flow in the fluid cavity. Magnets are placed at the top, bottom and surrounding a fluid cavity 1005. The magnets at the top and bottom of fluid cavity 1005 are not visible in this view (see FIG. 11). Fluid cavity 1005 is surrounded by a magnet 1006 in the shape of an annular ring. Magnet 1006 has a gap for an outlet port 1008. The interaction of current flow and magnetic flux density gives rise to a force on the fluid. The force accelerates the fluid in a circular manner till the fluid exits from outlet port 1008, producing useful pumping.

FIG. 11 shows a cross-sectional view of the centrifugal DC MHD pump of FIG. 10. A magnet 1102 is in the shape of a disc and is located on the top of fluid cavity 1005. Another magnet 1104 is in the shape of an annular ring and is located at the bottom of fluid cavity 1005. Fluid cavity 1005 has an inlet port 1106 on the axis at the bottom. The use of magnets 1006, 1102 and 1104 leads to an intensified magnetic flux density in fluid cavity 1005. The arrows in the figure show the direction of magnetization of the magnets. Magnet 1006 has a direction of magnetization 1108 pointing in the downward direction. Magnets 1102 and 1104 have directions of magnetization 1110 and 1112 pointing in the upward direction. The combined effect of magnets 1006, 1102 and 1104 lead to a strong magnetic field in fluid cavity 1005 pointing in the upward direction.

An electric current in the centrifugal MHD pump is generated through central electrode 1002 and perimeter electrode 1004. A bias applied between central electrode 1002 and perimeter electrode 1004 leads to the flow of current in the conducting fluid. The flow of current is radially outwards from central electrode 1002 to the perimeter electrode 1004.

The current flow in a direction perpendicular to the direction of magnetic field causes the fluid to experience a force. The force is in a direction perpendicular to both the magnetic field and the current flow. The force accelerates the fluid in a circular pattern. Due to the acceleration, the velocity of the fluid increases till the fluid finally exits from outlet port 1006 at a high velocity. This high-velocity fluid can be used to produce useful pumping. The use of magnetic configuration leads to an enhanced magnetic field density while the use of centrifugal MHD pump increases the path traveled by the charge carriers of the fluid. This leads to an improvement in the pumping capability of the DC MHD pump.

Also, the centrifugal pump allows the area of maximum current density to lie in the region of the pump with maximum magnetic flux density. The magnet arrangement, shown in the FIG. 10 and 11, for the centrifugal pump, has a maximum magnetic flux density in the center. The current is most dense at the center, where it leaves the central electrode. The current density decreases as the current travels out radially to the perimeter electrodes. Thus a centrifugal pump allows for maximum force to be transferred to the fluid. In contrast, in a linear DC pump, often a magnet structure creates a point of maximum magnetic flux density in the center of the channel. The most dense region of current is typically is at the edges of the structure, and cannot be effectively located in the point of maximum magnetic flux density. Thus the centrifugal configurations provided by the invention lead to an improved pumping capability of the pump.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A centrifugal direct current magnetohydrodynamic pump for pumping conductive fluids, the centrifugal direct current magnetohydrodynamic pump comprising:
a. a housing enclosing a working chamber wherein the working chamber contains conductive fluid;
b. a pair of electrodes in the working chamber for generating a current flow, the pair comprising:
i. a perimeter electrode, the perimeter electrode enclosing a fluid cavity, the fluid cavity being filled with the conductive fluid; and
ii. a central electrode, the central electrode being located on an axis in the center of the fluid cavity;
c. an inlet port located on the axis of the fluid cavity, the inlet port allowing the conductive fluid filled in the working chamber to enter the fluid cavity;
d. an outlet port on the perimeter of the fluid cavity; and
e. a magnetic circuit for generating a magnetic field in the fluid cavity, the direction of the magnetic field being perpendicular to direction of current flow
whereby the fluid entering the fluid cavity through the inlet port experiences a force in a direction perpendicular to the plane of magnetic field and current flow, the force accelerating the fluid in a circular pattern, the accelerated fluid coming out of the outlet port producing useful pumping.

2. The centrifugal direct current magnetohydrodynamic pump as recited in claim 1 wherein the perimeter electrode comprises one or more conductors arranged in the shape of a cylinder.

3. The centrifugal direct current magnetohydrodynamic pump as recited in claim 1 wherein the perimeter electrode comprises one or more conductors arranged in the shape of a volute.

4. The centrifugal direct current magnetohydrodynamic pump as recited in claim 1 wherein the inlet port is located at the bottom of the fluid cavity.

5. The centrifugal direct current magnetohydrodynamic pump as recited in claim 1 wherein the central electrode is located at the top of the cavity.

6. The centrifugal direct current magnetohydrodynamic pump as recited in claim 1 wherein the central electrode is located at the bottom of the cavity.

7. The centrifugal direct current magnetohydrodynamic pump as recited in claim 1 wherein the central electrode comprises multiple electrodes.

8. The centrifugal direct current magnetohydrodynamic pump as recited in claim 1 wherein the perimeter electrode comprises a continuous conductor.

9. The centrifugal direct current magnetohydrodynamic pump as recited in claim 1 wherein the perimeter electrode comprises one or more discrete conductors.

10. The centrifugal direct current magnetohydrodynamic pump as recited in claim 1 wherein the magnetic circuit for generating the magnetic flux density comprises a two magnet configuration for enhancing the magnetic flux density, the magnets being located at the top and bottom of the fluid cavity, the magnets having the direction of magnetization in the same direction.

11. The centrifugal direct current magnetohydrodynamic pump as recited in claim 1 wherein the magnetic circuit for generating the magnetic flux density comprises three magnet configuration for enhancing the magnetic flux density, the configuration comprising:
a. a first magnet in the shape of a disc located at the top of the fluid cavity;
b. a second magnet in the shape of a ring located at the bottom of the fluid cavity, the magnet providing space for the inlet port, the second magnet having the same direction of magnetization as the first magnet; and
c. a third magnet located on the perimeter of the fluid cavity, the third magnet having the direction of magnetization opposite to the first and second magnets.

12. A magnet configuration providing magnetic flux density in a fluid cavity for enhanced performance in direct current magnetohydrodynamic pump, the magnet configuration comprising:
a. a first pair of magnets with a magnet located at the top and another at the bottom of the fluid cavity, the magnets having the same direction of magnetization; and
b. a second pair of magnets located on the sides of the fluid cavity, the second pair of magnets having the direction of magnetization opposite to the first pair of magnets.

13. A magnetic configuration providing magnetic flux density in a fluid cavity for enhanced performance in direct current magnetohydrodynamic pump, the magnetic configuration comprising a Halbach magnet array configuration enclosing the fluid cavity.

14. A magnetic configuration providing magnetic flux density in a fluid cavity for enhanced performance in direct current magnetohydrodynamic pump, the magnetic configuration comprising:
a. a first magnetic structure located at the top of the fluid cavity, the magnetic structures comprising a plurality of magnets arranged with the direction of magnetization perpendicular to the adjacent magnets; and
b. a second magnetic structure located at the bottom of the fluid cavity, the magnetic structures comprising a plurality of magnets arranged with the direction of magnetization perpendicular to the adjacent magnets.

15. A centrifugal direct current magnetohydrodynamic pump for pumping conducting fluids, the direct current magnetohydrodynamic pump comprising:
a. a housing incorporating a working chamber wherein the working chamber contains conductive fluid;
b. a pair of electrodes in the working chamber for generating a current flow, the pair comprising:
i. a perimeter electrode, the perimeter electrode enclosing a fluid cavity, the fluid cavity being filled with the conductive fluid; and
ii. a central electrode, the central electrode being located in the center of the fluid cavity;
c. an inlet port located on the axis of the fluid cavity, the inlet port allowing the conductive fluid filled in the working chamber to enter the fluid cavity;
d. an outlet port on the perimeter of the fluid cavity; and
e. a magnetic circuit for generating a magnetic flux density in the fluid cavity, the magnetic circuit comprising:
i. a first magnet in the shape of a disc located at the top of the fluid cavity;
ii. a second magnet in the shape of an annular ring located around the perimeter of the fluid cavity, the second magnet having the direction of magnetization opposite to the first magnet, the second magnet providing space for the outlet port; and
iii. a third magnet in the shape of an annular ring located below the fluid cavity, the third magnet having the same direction of magnetization as the first magnet, the third magnet providing space for the inlet port in the center.

16. The centrifugal direct current magnetohydrodynamic pump as recited in claim 15 wherein the central electrode is located at the top of the cavity.

17. The centrifugal direct current magnetohydrodynamic pump as recited in claim 15 wherein the central electrode is located at the bottom of the cavity.

18. The centrifugal direct current magnetohydrodynamic pump as recited in claim 15 wherein the central electrode comprises multiple electrodes.

19. The centrifugal direct current magnetohydrodynamic pump as recited in claim 15 wherein the perimeter electrode comprises a continuous conductor.

20. The centrifugal direct current magnetohydrodynamic pump as recited in claim 15 wherein the perimeter electrode comprises one or more discrete conductors.
